(19) United States
(12) Patent Application Publication
(10) Pub. No.: US 2012/0301207 A1
(43) Pub. Date: Nov. 29, 2012

(54) COMBINATION STORAGE UNIT AND APPLICATOR FOR PAINT AND OTHER SURFACE COATING LIQUIDS

(76) Inventors: John J. Kriesel, Hugo, MN (US); Kathy Ann Kriesel, Hugo, MN (US)

(21) Appl. No.: 13/113,377

(22) Filed: May 23, 2011

(51) Int. Cl. B05C 1/06; A46B 11/02; B05C 17/005

(52) U.S. Cl. 401/129; 401/126; 401/130

(57) ABSTRACT

A device for touching up painted areas comprises a flexible container, and an applicator support connected to an opening of the container by threads or other attachment means. The applicator support carries an applicator for receiving paint or other coating material held in the container. The applicator is porous, allowing one to apply the paint to the painted areas in need of touch-up by squeezing the container. A cap having an interior space sized to contain the applicator can attach to the applicator support or container to enclose the applicator thereby creating a substantially airtight seal and preventing paint in the applicator and the container from drying out. By detaching the applicator support from the container, paint may be poured into the container.

### BACKGROUND OF THE INVENTION

Surfaces are often coated for esthetic and protective purposes. Typically, this coating is applied as a liquid that then dries (hardens) to a layer that beautifies and protects the underlying material. This liquid will be hereafter referred to as “paint”, but may be any type of permanent or semi-permanent coating applied as a liquid to a surface of any kind. The process of applying this coating is universally known as “painting” and a surface so coated as a “painted” surface.

The apparatus to be described is directed to maintaining the integrity of painted surfaces of buildings but also pertains to other types of painted surfaces, for example, vehicles and exterior furniture.

Afterwards the initial coating is complete, people and animals interact with the painted surfaces and often through carelessness or inadvertence, damage relatively small areas of the coated surfaces. Frequently after paint has been applied to a surface, a quantity of the paint remains. This leftover paint is useful for repainting the damaged areas.

It is the usual practice to keep the leftover paint in the original container and simply apply this paint with a brush, pad, or roller after damage occurs to a surface. However, this practice has numerous disadvantages. In the first place, the leftover paint more often than not occupies only a small fraction of the container. The paint may for this reason skin over or dry out because most of the volume in the container is air.

Secondly, paint is usually supplied in gallon containers, which inconveniently occupy a significant amount of shelf space. Third, the seal between the cover and the container itself may be compromised when paint dries in the sealing grooves during the painting process. Fourth, deteriorated paint must be replaced, and it is by no means certain that the replacement paint will match the original paint, and in any case it is expensive and inconvenient to do so. One can see that usual practice in this situation is problematic.

A number of solutions for this problem already exist. For example, U.S. Pat. No. 6,439,381 teaches individual storage containers for a number of different paints. '381 shows an applicator that must be attached to the container before touchup and then either cleaned or discarded after touchup is done.

U.S. Pat. No. 7,040,828 discloses a container for touchup paint having an applicator carried by a support that screws into the container. The user removes the applicator by unscrewing its support from the container. The applicator, having already been immersed in the paint, is instantly usable. The invention contemplates attaching the applicator to the container with a second thread set to prevent the paint in the container from drying while touching up occurs and to serve as a handle during the touchup process.

U.S. Pat. No. 7,338,227 discloses a system for mixing two parts for an epoxy paint and includes an applicator for touching up an existing coating.

Each of these designs solves the problem in some sense, but have disadvantages as well.

### BRIEF DESCRIPTION OF THE INVENTION

An improved device for applying relatively small quantities of a liquid coating material such as paint comprises a container having an interior space defined by flexible walls, and having an opening for filling the interior space with a liquid coating material. This container opening has a first annular attachment feature. The first annular attachment feature preferably comprises relatively rigid threads encircling the container opening.

A coating material applicator has a porous applicator surface for receiving a liquid coating material. The applicator further comprises structure that distributes the coating material to the applicator surface.

An applicator support has a second annular attachment feature that can mate with the first annular attachment feature to form a seal opposing migration of liquid between the first and second annular attachment features. The applicator support also has an interior passage in flow communication with the applicator. When the second annular attachment feature is mated with the first annular attachment feature said applicator surface is in flow communication with the container's interior space.

A cap has an interior space sized to contain or enclose the applicator portion exterior to the container. The cap has an opening defined by a third annular attachment feature. The third annular attachment feature can mate with one or the other of the first and second annular attachment features to create a substantially airtight seal between them.

When the cap's third annular attachment feature is so mated with the one of the first and second annular attachment features, the cap's interior space holds the applicator. Little or no external air can reach the container interior space and the applicator, preventing paint held within the container and the applicator from hardening.

When touching up an area of the painted surface, the user squeezes the flexible walls of the container, reducing the internal space and forcing paint through the applicator from the first to the second applicator end portion. Liquid paint appears on the second end and may be then applied to the touchup area.

In one preferred version, the applicator comprises pliable, permeable, foam material. By squeezing the container walls, a user can force paint in the container through the applicator support and the applicator itself to the applicator surface. The coating material appears on the applicator surface, from which it may be transferred to a surface such as a wall. Releasing the container walls allow air exterior to the container to pass through at least a part of the applicator support to the container interior, replacing the volume of coating material previously applied and allowing the container walls to return to their unstressed (normal) shape.

In a second embodiment, the applicator support includes a tubular projection in flow communication with the applicator support's interior passage. The applicator includes a plenum mounted on and having an interior space in flow communication with the tubular projection. The plenum has a surface having an aperture therein and facing away from the tubular projection, and defining in part the plenum's interior space. A permeable fabric pad overlies the plenum's flat surface and the aperture therein to form the applicator surface.

In either embodiment, a vent in the applicator support can function to allow airflow to the container interior space.

### BRIEF DESCRIPTION OF THE DRAWINGS

FIG. 1 is a perspective view of a liquid coating material application device when in a “storage configuration.”

FIG. 2. is an exploded perspective view of the liquid coating material application device, showing the various components thereof.

FIG. 3 is a perspective view of an alternate configuration for an applicator element of the liquid coating material application device.

### DESCRIPTION OF THE PREFERRED EMBODIMENTS

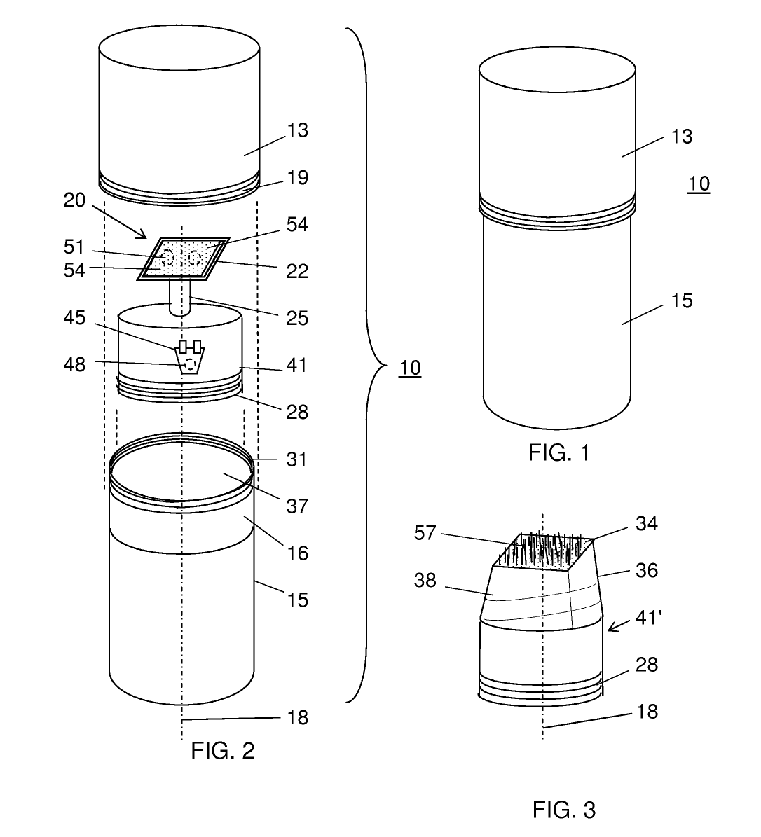

Referring first to FIGS. 1 and 2, the liquid coating material application device 10 shown therein provides the user with structure into which leftover paint or other liquid coating material may be place for later touch and repair use. Device 10 is intended for use with liquids such as paint that harden or dry when exposed to air for a period of time.

The exploded view of FIG. 2 discloses a container 15 having a mouth 37 and a longitudinal axis 18. The walls of container 15 are flexible so that a typical user can compress them with hand force alone to reduce the volume of container 15. A first annular attachment feature 31 encircles mouth 37, and in a preferred embodiment comprises threads. Container 15 includes a relatively rigid tubular ring or band 16 defining mouth 37 into which the threads comprising a first annular attachment feature 31 may be molded.

An applicator support 41 has an interior passage allowing liquids to flow through support 41 generally along axis 18. Support 41 in one preferred embodiment includes a tubular projection 25 in flow communication with this interior passage.

Support 41 includes a second annular attachment feature 28 shown here as threads encircling an opening of support 41. Second annular attachment feature 28 is designed to mate with the threads comprising the first annular attachment feature 31 to attach support 41 to container 15 and form a seal opposing migration of liquid between the threads comprising the first and second annular attachment features 31 and 28. FIG. 2 shows second annular attachment feature 28 structured to thread into the interior of container 15.

A coating material applicator 20 in one version of this invention includes a plenum 22 carried by projection 25. “Plenum” in the context here means a structure having an enclosed space in which liquid coating material can flow. Plenum 22 has an interior space in flow communication with projection 25.

Plenum 22 includes a wall 27 facing away from projection 25 and defining at least a part of the plenum space. Wall 27 has at least one aperture 51. A permeable fabric pad 54 on the wall 27 overlies aperture 51. Preferably wall 27 is substantially rectangular and tilted with respect to axis 18. Wall 27 and plenum 22 may be semi-rigid, resisting flexure, but also allowing some deflection of these components to conform to a wall surface.

Liquid coating material such as paint is poured into container 15 and then support 41 is threaded into container 15. By tilting the assembly so that applicator 20 is below container 15, and then squeezing the flexible walls of container 15, liquid is forced through projection 25 and aperture 51 to soak pad 54. Rubbing or dabbing pad 54 on a surface then applies the liquid to the surface.

The intent here is for a user to fill container 15 with leftover paint or other liquid coating material when an entire surface such as a wall is first coated. After filling container 15, then applicator support 41 is mated with container 15. First and second annular attachment features 31 and 28 form a seal preventing migration of air into the container 15. However, air can migrate into container 15 through applicator 20 and applicator support 41. This will cause the liquid within container 15 and applicator 20 to eventually harden and become worthless.

A cap 13 that encloses container 15 and applicator 20 will prevent deterioration of paint within them. Cap 13 has an interior space sized to contain applicator 20 and in this embodiment, fit around applicator support 41 as well. Cap 13 has an opening defined by a third annular attachment feature 19, and in the preferred embodiment shown here comprises threads that mate with one of the other of the first and second annular attachment features 31 and 28.

For example, first annular attachment feature 31 may comprise threads molded into the wall of container 15 that are engageable both for the interior and exterior of container 15. In this embodiment, the configuration of the threads comprising third annular attachment feature 19 allow their mating with the exterior pattern of first annular attachment feature 31 on container 15. Thus the threads comprising first annular attachment feature 31 mate with the second annular attachment feature 28 on the inside of container 15 and also mate with the third annular attachment feature 19 on the outside of container 15.

The first and third annular attachment features 31 and 19 have a mating connection that forms a substantially airtight seal to prevent migration of air into the space between cap 13 and support 41. The liquid material in container 15 and applicator 20 will not normally dry out or harden when exposed to such a small volume of air. Accordingly, the liquid may be suitable for use even years after attaching the cap 13 to container 15 using the first and third annular attachment features 31 and 19.

It is likely that the smaller volume of air in intimate contact with the liquid material in container 15 and applicator 20 means that the shelf life of the material in container 15 will be longer than if left in a conventional can from which much of the coating material has already been removed and replaced with air.

Further experience may show that threads alone comprising mated annular attachment features 28 and 31 may not provide adequate sealing against migration of coating material from container 31 between them. Experience may also show that threads alone comprising mated annular attachment features 19 and 31 may not provide adequate sealing against migration of air between them into the internal space of cap 13. In that case, an O-ring or other type of gasket may be necessary to provide the desired performance.

It is also possible that attachment features other than mated threads will serve to prevent air from entering the space that cap 13 encloses. For example, the caps that prevent felt tip markers from drying have a simple type of close-fitting detent that is substantially airtight. Note however, that the openings of these caps are typically only ½″ or in diameter. It may be true that such detent-type caps do not scale up effectively to a cap than may be 1-3″ in diameter, if for no other reason than attaching and detaching the cap requires too much strength.

In another design not currently preferred, the configuration of the threads comprising third annular attachment feature 19 allows their mating with the threads comprising second annular attachment feature 28. In this case, the threads of second annular attachment feature 28 should extend axially along support 41 to an amount sufficient to allow engagement with third annular attachment feature 19.

Typically after application and during use, a wall coating becomes damaged in only a few places. It is a great convenience for a user to simply remove cap 13, squeeze the flexible walls of container 15 to force a suitable amount of liquid into applicator 20 for application to the damaged spots.

In the case of latex paint as the coating material, it may be helpful to simply run water over applicator 20 for a few seconds before attaching cap 13. This removes and dilutes the paint within pad 54 and thereby lengthens the time that the paint remains usable.

Experience may show that air does not flow freely into container 15 through applicator 20 when releasing pressure on the walls of container 15. If that is the case, vent hole 49 and closure flap 45 may allow airflow into container 15. In the example shown, flap 45 is biased to move away from vent hole 49. The user presses flap 45 against hole 48 when squeezing the container 15 walls to prevent liquid from seeping through hole 48. Other types of vents such as self-closing vents may be usable as well.

FIG. 3 shows another embodiment have an alternate applicator support 41′ and applicator 36, and is intended to thread directly into container 15 of FIG. 1. Support 41′ comprises a hollow tube having threads 28 that will mate with the threads 37 of container 15. Possibly the support 41′ and applicator 36 will be included in a commercial kit that also includes the components of FIG. 1.

Applicator 36 comprises a permeable open cell foam block that fits closely within support 41′ and bonds to the interior walls thereof. The sidewall surface 38 of applicator 36 has a coating or layer substantially impervious to passage of coating material.

The end surface 34 of applicator 36 is preferably substantially flat and rectangular, and tilted with respect to axis 18. Surface 34 must be permeable for the coating material, to allow coating material to flow to the surface. Surface 34 may have bristles 57 as shown or a permeable fabric surface to assist in applying the coating material to the surface to be coated, and to provide a desired texture of the final wall surface.

By squeezing the walls of container 15 when applicator support 41′ is mounted thereon, coating material is forced through applicator 36 to surface 34. The coating material on surface 34 can then be applied to a surface as with the device of FIG. 1. Sidewall 38 should be impervious to flow of coating material to properly channel coating material to surface 34.

If experience shows that insufficient air can flow backwards through a fully saturated foam applicator 36, a vent arrangement as shown in FIG. 2 may be necessary to allow replenishing air in container 15.

When a particular project is complete, the user attaches cap 13 by mating the threads comprising annular attachment feature 19 and the outside of annular attachment feature 31. If desired, a user may wish to rinse out applicator 36 partially or completely before attaching cap 13.

1. A liquid coating material applier device comprising:
a) a container having an interior space defined by flexible walls, and having an opening for filling the interior space with a liquid coating material, said opening having a first annular attachment feature;
b) a coating material applicator having a porous applicator surface, said applicator for receiving a liquid coating material and distributing the coating material to the applicator surface;
c) an applicator support carrying the applicator, and having a second annular attachment feature that can mate with the container's first annular attachment feature to form a seal opposing migration of liquid between the first and second annular attachment features, said applicator support having an interior passage in flow communication with the applicator and the container's interior space, and when the second annular attachment feature is mated with the first annular attachment feature said applicator surface is in flow communication with the container's interior space; and
d) a cap having an interior space sized to contain the applicator, said cap having an opening defined by a third annular attachment feature, said third annular attachment feature mating with one of the first and second annular attachment features to create a substantially airtight seal therebetween, and when so mated holding the applicator within the cap's interior space.

2. The device of claim 1, wherein the applicator support comprises a rigid tubular ring carrying the second annular attachment feature and the applicator comprises an open cell foam material, a first portion of said foam material within the ring's interior passage and a second portion extending from the applicator support and carrying an end surface forming the applicator surface, and when the first and second attachment features are mated, the first end portion of the applicator is within the container and the second end is external to the container.

3. The device of claim 2, wherein the applicator further comprises a plurality of bristle-like projections from the second end portion of the applicator.

4. The device of claim 2, wherein the container has a longitudinal axis and wherein the applicator surface is substantially flat and rectangular, and tilted with respect to the longitudinal axis.

5. The device of claim 2, wherein the applicator surface further comprises a permeable pad.

6. The device of claim 2 wherein the applicator support includes an area having a vent therein allowing airflow through the applicator support to the container's interior space.

7. The device of claim 2, wherein a portion of the cell foam material exterior to the applicator support has an exterior layer resistant to air passage.

8. The device of claim 1, wherein the applicator support includes a tubular projection in flow communication with the applicator support's interior passage, and wherein the applicator includes
a) a plenum mounted on and having an interior space in flow communication with the tubular projection, and having a surface having an aperture therein and facing away from the tubular projection, and defining in part the interior space; and
b) on the plenum's flat surface and overlying the aperture therein, a permeable fabric pad forming the applicator surface.

9. The device of claim 8, wherein the container has a longitudinal axis and wherein the applicator surface is substantially flat and rectangular, and tilted with respect to the longitudinal axis.

10. The device of claim 1, wherein the annular attachment features each comprise a threaded surface encircling its associated opening.

11. The device of claim 10, wherein the third annular attachment feature mates with the first annular attachment feature.

12. The device of claim 10, wherein the third annular attachment feature mates with the second annular attachment feature.

13. The device of claim 1 wherein the applicator comprises plastic foam material having a plurality of open cells, and having a first end portion within the applicator support's interior passage and in flow communication with the container's interior space, and a second end portion defining the applicator surface, said foam material having permeability allowing air flow through the cells thereof from the second to the first end portions thereof.

14. The device of claim 1, wherein the applicator support includes a side wall, and the air flow means comprises a valve in the side wall.

15. The device of claim 14, wherein the valve comprises a vent in the sidewall of the applicator support, and a flap seal overlying the vent and having resilience that naturally holds the flap away from the side wall.

16. The device of claim 1 wherein the applicator support comprises a tube projecting away from the container and in flow communication therewith, and wherein the applicator comprises a pad having a wall with a perforation in flow communication with the tube, and a permeable flocked layer supported by the backing plate and lying across the perforation.

17. The device of claim 1, including a substantially rigid band comprising the first attachment feature and a portion of the container adjacent to the first attachment feature.
